(19) United States
(12) Patent Application Publication
(10) Pub. No.: US 2024/0265541 A1
(43) Pub. Date: Aug. 8, 2024

(54) BIOLOGICAL CONTEXT FOR ANALYZING WHOLE SLIDE IMAGES

(71) Applicant: Genentech, Inc., South San Francisco, CA (US)

(72) Inventors: Trung Kien NGUYEN, Chelsea, MI (US); Yuan Liang, South San Francisco, CA (US)

(21) Appl. No.: 18/627,251

(22) Filed: Apr. 4, 2024

Related U.S. Application Data
(63) Continuation of application No. PCT/US22/46123, filed on Oct. 7, 2022.
(60) Provisional application No. 63/253,514, filed on Oct. 7, 2021.

(51) Int. Cl. G06T 7/00; G06T 7/50; G06T 11/00; G06V 20/69

(52) U.S. Cl. CPC G06T 7/0012; G06T 7/50; G06T 11/00; G06V 20/695; G06V 20/698; G06T 2207/10056; G06T 2207/20081; G06T 2207/30061; G06T 2207/30081; G06T 2207/30096

(57) ABSTRACT

Embodiments of a computer-implemented method for analyzing a whole slide image (WSI) in light of biological context may include extracting an embedding for each of a set of patches sampled from a WSI, wherein the embedding represents extracted one or more histological features of the respective patch of the WSI. For each of the patches, the corresponding embedding may be encoded with a spatial context and a semantic context. The spatial context may model attention to a local pattern related to the one or more histological features. The local pattern may span a region in the WSI beyond the corresponding patch. The semantic context may model attention to a global pattern over the WSI as a whole. A representation for the WSI may be generated by combining the encoded patch embeddings. A pathological task may then be performed based on the representation for the WSI.

### CROSS-REFERENCE TO RELATED APPLICATIONS

This application is a continuation of International Application No. PCT/US2022/046123, filed on Oct. 7, 2022, which claims the benefit of and the priority to U.S. Provisional Application No. 63/253,514, entitled “SELF-ATTENTION FOR MULTIPLE-INSTANCE LEARNING OF WSI” and filed on Oct. 7, 2021, which are hereby incorporated by reference in their entirety for all purposes.

### TECHNICAL FIELD

This application relates generally to digital pathology, and, more particularly, to analysis of a whole slide image (WSI).

### BACKGROUND

Analysis of digitized whole slide images (WSIs) depicting histological features are the gold standard for determining cancer diagnoses and prognoses. As clinical-grade scanners become more common, the potential for using machine-learning techniques to improve upon the diagnostic process using digital scans of WSIs is an exciting prospect. Working with WSIs may be difficult, however, due to the sheer size of digitized WSIs (e.g., 100K×100K pixels is a typical size). Since WSIs are so large, they are often broken down into smaller image tiles or patches for the purpose of analysis; however, the resulting output often only provides a weak, slide-level label, rather than detailed regional annotations. Standard automated analysis techniques based on machine-learning methods take each patch as an independent unit without modeling the biological context of the patch with respect to other patches in the WSI during aggregation. This contrasts with diagnostic practice where a pathologist refers to both microscopic (regional or local within the WSI) patterns and macroscopic (global within the WSI) context when analyzing WSIs-multiple regions of the WSI are commonly picked as patterns of interest by the pathologist and evaluated as a whole in order to draw diagnostic and/or prognostic conclusions.

### SUMMARY

In embodiments disclosed herein, a transformer-based aggregation model may model cross-patch dependencies between patches in a WSI to capture local and global patterns in the WSI. The transformer-based aggregation model may encode the embedding for each patch with two types of self-attention: a semantic self-attention to the appearance of all other patches in the slide to model slide-level patterns as global context (macroscopic context) and a spatial self-attention to nearby patches to disambiguate local patterns (microscopic context). In addition, an attention-based confidence regularization may be utilized to reduce over-emphasis on single patches for predictions.

In embodiments disclosed herein, a computer-implemented method for analyzing a whole slide image (WSI) in light of biological context may comprise extracting an embedding for each of a set of patches sampled from a WSI. The embedding may represent one or more histological features of the respective patch of the WSI. For each of the patches, the corresponding embedding may be encoded with a spatial context and a semantic context. The spatial context may represent a local pattern related to the one or more histological features, the local visual pattern spanning a region in the WSI beyond the corresponding patch. The semantic context may represent a global pattern over the WSI as a whole. A representation for the WSI may be generated by combining the encoded patch embeddings. Finally, a pathological task may be performed based on the representation for the WSI.

The patches may be sampled by applying a hierarchical sampling strategy to a randomly selected plurality of clusters of the patches. The hierarchical sampling strategy may be applied for each of the randomly selected clusters by randomly sampling a centroid of the cluster, determining, for each of the patches in the cluster, a distance of the patch to the centroid, and randomly sampling all patches in the cluster having a distance to the centroid within a threshold distance. The threshold distance may be based on the pathological task.

Encoding the embedding with the spatial context may comprise using a spatial encoder to encode the embedding with spatial attention by attending to embeddings of one or more nearby patches in the set. The nearby patches may be defined as those within a maximum relative distance corresponding to a specified pathological type of the WSI. Input for the spatial encoder may comprise a position of the corresponding patch and a sequence of absolute positions of the nearby patches. The absolute positions may be normalized to correspond to a standard level of magnification.

Encoding the embedding with a semantic context of the corresponding patch may comprise using a semantic encoder to encode the embedding with semantic attention by attending to embeddings of other patches in the set. The semantic encoder may be a bidirectional self-attention encoder with multi-head attention layers. The semantic encoder may attend embeddings of the other patches in the set. Input for the semantic encoder may comprise the embeddings of the other patches in the set and a learnable token.

During a training phase, generating a representation of the WSI based on the encoded patch embeddings may comprise generating an auxiliary representation based on the encoded learnable token.

The semantic context may be further enhanced by regularizing the semantic attention to reduce overemphasis on a few of the patches to generate the representation for the WSI. Regularizing the semantic attentions may comprise calculating, using a rollout operation, an attention map over all of the semantic attentions encoded for the embeddings corresponding to patches sampled from the WSI. A negative entropy of the attention map may then be added to a training objective of the transformer model as a hinge loss.

Combining the encoded patch embeddings may comprise taking an average of the encoded embeddings.

Performing a pathological task based on the annotation of the WSI may comprise classifying the one or more histological features extracted from the WSI, classifying a pathological type of the WSI, predicting a progression risk of a disease associated with the one or more histological features, or determining a diagnosis of a patient associated with the WSI. The pathological task may be performed using a classifier model or a regressor model.

One or more computer-readable non-transitory storage media embodying software comprising instructions operable when executed to perform steps of the methods disclosed herein.

A system comprising one or more processors and a memory coupled to the processors comprising instructions executable by the processors, the processors being operable when executing the instructions to perform steps of the methods disclosed herein.

In embodiments disclosed herein, a computer-implemented method for analyzing a whole slide image (WSI) in light of biological context may comprise extracting an embedding for each of a set of patches sampled from a WSI, wherein the embedding represents one or more histological features of the respective patch of the WSI. For each of the patches: a spatial encoder may encode the embedding corresponding to the patch with a spatial attention by attending to the embeddings of nearby patches in the set, wherein the spatial attention models attention to a microscopic visual pattern related to the one or more histological features, the microscopic visual pattern spanning a region in the WSI beyond the corresponding patch; and a semantic encoder may encode the embedding corresponding to the patch with a semantic attention by attending to the embeddings of all other patches in the set, wherein the semantic attention models attention to a macroscopic visual pattern over the WSI as a whole. A representation for the WSI may be generated by combining the encoded patch embeddings, and a pathological task may be performed based on the representation for the WSI.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a network of interacting computer systems.

FIG. 2 illustrates an example model for analyzing WSI in light of biological context.

FIG. 3 is a flowchart depicting steps in an example method for analyzing WSI in light of biological context information.

FIG. 4A illustrates an example of a whole slide image including an annotated tumor region.

FIG. 4B illustrates an enlarged view of the annotated tumor region depicted in FIG. 4A.

FIG. 4C illustrates an example of an attention map visualization utilizing an attention-based multiple-instance learning technique.

FIG. 4D illustrates an enlarged view of a non-tumor region depicted in FIG. 4C.

FIG. 4E illustrates an example of an attention map visualization utilizing a semantic self-attention technique.

FIG. 4F illustrates an enlarged view of a non-tumor region depicted in FIG. 4E.

FIG. 4G illustrates an example of an attention map visualization utilizing a semantic self-attention technique and an entropy-based attention regularization mechanism.

FIG. 4H illustrates an example of an attention map visualization utilizing a semantic self-attention technique, an entropy-based attention regularization mechanism, and a spatial self-attention technique.

FIG. 4I illustrates a comparison between the attention map of FIG. 4G and the attention map of FIG. 4H with respect to the annotated tumor region.

FIG. 4J illustrates a comparison between the attention map of FIG. 4G and the attention map of FIG. 4H with respect to a non-tumor region.

FIG. 5 illustrates an example computer system.

### DESCRIPTION OF EXAMPLE EMBODIMENTS

Multiple-instance learning may be used to tackle both the need to break down WSIs into smaller image patches, as well as the issue with weak, slide-level labels. Multiple-instance learning operates at the patch level and identifies patches (e.g., regions) of a WSI that contribute to the weak label. WSIs are broken down into smaller patches and then, using a weak slide-level label only, a neural network is trained to identify which patches contribute to the slide-level label. Here, the main difficulty of multiple-instance learning lies in aggregating patch-level insights to the slide level.

Generally, multiple-instance learning models applied to the analysis of WSIs begin by treating each WSI as a “bag” of patches. A label for the bag is predicted by (i) patch feature extraction and (ii) feature aggregation. Subsequently, the aggregated features are used as the slide representation for the final prediction. To accomplish feature aggregation, certain techniques may rely on handcrafted operations, e.g., max pooling, and other techniques may utilize a learnable network to predict the aggregation weight of a patch conditioned on its visual semantics in order to accentuate the most related patches for diagnosis among prevailing unrelated ones. However, generic multiple-instance learning methods take each patch as an independent unit without taking its biological context into account during aggregation. This is in contrast to diagnostic pathology practice where a pathologist looks at both microscopic patterns and their macroscopic context.

Certain techniques consider cross-patch dependencies during aggregation. One example technique develops graph neural networks over pre-defined regions of interests as vertices in order to capture significant regions of a slide. In another example technique, a single distance layer is trained to measure the semantic similarity between a critical patch and other patches in order to estimate the contribution of patches to the slide-level label. With these techniques, only dependencies across a selected subset of patches are modeled, e.g., dependencies related to a single critical patch or over a pre-defined region.

In the present embodiments, a transformer-based aggregation model models cross-patch dependencies between all patches in a set of patches selected from a WSI to capture local and global patterns in the WSI. After generating embeddings of the selected patches (e.g., feature vectors representing specific histological features relevant to a particular pathology), self-attention mechanisms encode the embedding for each of the patches by combining information from certain other ones of the embeddings into the representation of the focal embedding. Specifically, the transformer-based aggregation model includes two types of self-attention for each patch: (i) a semantic self-attention, which combines information about the appearance of all other patches in the slide to model slide-level patterns as global context (e.g., macroscopic context), and (ii) a spatial self-attention, which combines information about nearby patches to disambiguate local patterns (e.g., microscopic context). In addition, an attention-based confidence regularization is utilized to reduce over-emphasis on single patches for predictions. The functioning of the transformer-based aggregation model with a tumor-grading classification task (e.g., using a classifier model) and a survival prediction regression task (e.g., using a regressor model) are described herein.

To evaluate the transformer-based aggregation model comprehensively, two different types of pathological tasks are tested: tumor grading in prostate cancer and survival prediction in lung cancer. Both tasks are challenging with complex underlying pathological mechanisms. The present methods achieve new state-of-the-art accuracy in both tasks, outperforming existing results by 3.59% and 1.64% in x-score and C-index, respectively.

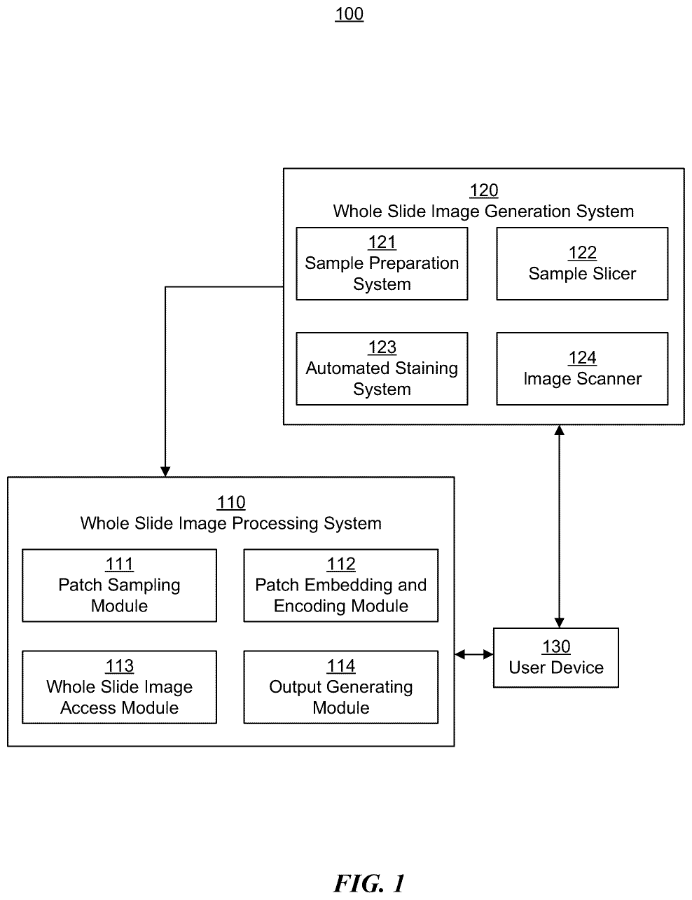

FIG. 1 illustrates a network 100 of interacting computer systems that may be used, as described herein according to some embodiments of the present disclosure.

A whole slide image generation system 120 may generate one or more whole slide images or other related digital pathology images, corresponding to a particular sample. For example, an image generated by whole slide image generation system 120 may include a stained section of a biopsy sample. As another example, an image generated by whole slide image generation system 120 may include a slide image (e.g., a blood film) of a liquid sample. As another example, an image generated by whole slide image generation system 120 may include fluorescence microscopy such as a slide image depicting fluorescence in situ hybridization (FISH) after a fluorescent probe has been bound to a target DNA or RNA sequence.

Some types of samples (e.g., biopsies, solid samples and/or samples including tissue) may be processed by a sample preparation system 121 to fix and/or embed the sample. Sample preparation system 121 may facilitate infiltrating the sample with a fixating agent (e.g., liquid fixing agent, such as a formaldehyde solution) and/or embedding substance (e.g., a histological wax). For example, a sample fixation sub-system may fix a sample by exposing the sample to a fixating agent for at least a threshold amount of time (e.g., at least 1 hours, at least 6 hours, or at least 13 hours). A dehydration sub-system may dehydrate the sample (e.g., by exposing the fixed sample and/or a portion of the fixed sample to one or more ethanol solutions) and potentially clear the dehydrated sample using a clearing intermediate agent (e.g., that includes ethanol and a histological wax). A sample embedding sub-system may infiltrate the sample (e.g., one or more times for corresponding predefined time periods) with a heated (e.g., and thus liquid) histological wax. The histological wax may include a paraffin wax and potentially one or more resins (e.g., styrene or polyethylene). The sample and wax may then be cooled, and the wax-infiltrated sample may then be blocked out.

A sample slicer 122 may receive the fixed and embedded sample and may produce a set of sections. Sample slicer 122 may expose the fixed and embedded sample to cool or cold temperatures. Sample slicer 122 may then cut the chilled sample (or a trimmed version thereof) to produce a set of sections. Each section may have a thickness that is (for example) less than 100 μm, less than 50 μm, less than 10 μm or less than 5 μm. Each section may have a thickness that is (for example) greater than 0.1 μm, greater than 1 μm, greater than 2 μm or greater than 4 μm. The cutting of the chilled sample may be performed in a warm water bath (e.g., at a temperature of at least 10° C., at least 15° C. or at least 40° C.).

An automated staining system 123 may facilitate staining one or more of the sample sections by exposing each section to one or more staining agents. Each section may be exposed to a predefined volume of staining agent for a predefined period of time. In some instances, a single section is concurrently or sequentially exposed to multiple staining agents.

Each of one or more stained sections may be presented to an image scanner 124, which may capture a digital image of the section. Image scanner 124 may include a microscope camera. The image scanner 124 may capture the digital image at multiple levels of magnification (e.g., using a 10× objective, 20× objective, 40× objective, etc.). Manipulation of the image may be used to capture a selected portion of the sample at the desired range of magnifications. Image scanner 124 may further capture annotations and/or morphometrics identified by a human operator. In some instances, a section is returned to automated staining system 123 after one or more images are captured, such that the section may be washed, exposed to one or more other stains, and imaged again. When multiple stains are used, the stains may be selected to have different color profiles, such that a first region of an image corresponding to a first section portion that absorbed a large amount of a first stain may be distinguished from a second region of the image (or a different image) corresponding to a second section portion that absorbed a large amount of a second stain.

It will be appreciated that one or more components of whole slide image generation system 120 can, in some instances, operate in connection with human operators. For example, human operators may move the sample across various sub-systems (e.g., of sample preparation system 121 or of whole slide image generation system 120) and/or initiate or terminate operation of one or more sub-systems, systems, or components of whole slide image generation system 120. As another example, part or all of one or more components of whole slide image generation system (e.g., one or more subsystems of the sample preparation system 121) may be partly or entirely replaced with actions of a human operator.

Further, it will be appreciated that, while various described and depicted functions and components of whole slide image generation system 120 pertain to processing of a solid and/or biopsy sample, other embodiments may relate to a liquid sample (e.g., a blood sample). For example, whole slide image generation system 120 may receive a liquid-sample (e.g., blood or urine) slide that includes a base slide, smeared liquid sample and cover. Image scanner 124 may then capture an image of the sample slide. Further embodiments of the whole slide image generation system 120 may relate to capturing images of samples using advancing imaging techniques, such as FISH, described herein. For example, once a florescent probe has been introduced to a sample and allowed to bind to a target sequence appropriate imaging may be used to capture images of the sample for further analysis.

A given sample may be associated with one or more users (e.g., one or more physicians, laboratory technicians and/or medical providers) during processing and imaging. An associated user may include, by way of example and not of limitation, a person who ordered a test or biopsy that produced a sample being imaged, a person with permission to receive results of a test or biopsy, or a person who conducted analysis of the test or biopsy sample, among others. For example, a user may correspond to a physician, a pathologist, a clinician, or a subject. A user may use one or one user devices 130 to submit one or more requests (e.g., that identify a subject) that a sample be processed by whole slide image generation system 120 and that a resulting image be processed by a whole slide image processing system 110.

Whole slide image generation system 120 may transmit an image produced by image scanner 124 back to user device 130. User device 130 then communicates with the whole slide image processing system 110 to initiate automated processing of the image. In some instances, whole slide image generation system 120 provides an image produced by image scanner 124 to the whole slide image processing system 110 directly, e.g., at the direction of the user of a user device 130. Although not illustrated, other intermediary devices (e.g., data stores of a server connected to the whole slide image generation system 120 or whole slide image processing system 110) may also be used. Additionally, for the sake of simplicity only one whole slide image processing system 110, image generating system 120, and user device 130 is illustrated in the network 100. This disclosure anticipates the use of one or more of each type of system and component thereof without necessarily deviating from the teachings of this disclosure.

The network 100 and associated systems shown in FIG. 1 may be used in a variety of contexts where scanning and evaluation of digital pathology images, such as whole slide images, are an essential component of the work. As an example, the network 100 may be associated with a clinical environment, where a user is evaluating the sample for possible diagnostic purposes. The user may review the image using the user device 130 prior to providing the image to the whole slide image processing system 110. The user may provide additional information to the whole slide image processing system 110 that may be used to guide or direct the analysis of the image by the whole slide image processing system 110. For example, the user may provide a prospective diagnosis or preliminary assessment of features within the scan. The user may also provide additional context, such as the type of tissue being reviewed. As another example, the network 100 may be associated with a laboratory environment where tissues are being examined, for example, to determine the efficacy or potential side effects of a drug. In this context, it may be commonplace for multiple types of tissues to be submitted for review to determine the effects on the whole body of said drug. This may present a particular challenge to human scan reviewers, who may need to determine the various contexts of the images, which may be highly dependent on the type of tissue being imaged. These contexts may optionally be provided to the whole slide image processing system 110.

Whole slide image processing system 110 may process digital pathology images, including whole slide images, to classify the digital pathology images and generate annotations for the digital pathology images and related output. A patch sampling module 111 may identify a set of patches for each digital pathology image. To define the set of patches, the patch sampling module 111 may segment the digital pathology image into the set of patches. As embodied herein, the patches may be non-overlapping (e.g., a patch includes pixels of the image not included in any other patch) or overlapping (e.g., a patch includes some portion of pixels of the image that are included in at least one other patch). Features such as whether or not patches overlap, in addition to the size of each patch and the centroid of the patch (e.g., the image distance or pixels between a centroid of a patch and a centroid of a nearby patch) may increase or decrease the data set for analysis, wherein sampling a greater number of patches from the WSI (e.g., through overlapping or smaller patches) may increase the potential resolution of eventual output and visualizations. In some instances, patch sampling module 111 defines a set of patches for an image where each tile is of a predefined size and/or an offset between tiles is predefined.

Furthermore, the patch sampling module 111 may create multiple sets of tiles of varying size, overlap, step size, etc., for each image. In some embodiments, the digital pathology image itself may contain tile overlap, which may result from the imaging technique. Even segmentation without tile overlapping may be a preferable solution to balance tile processing requirements and avoid influencing the embedding generation and weighting value generation discussed herein. A tile size or tile offset may be determined, for example, by calculating one or more performance metrics (e.g., precision, recall, accuracy, and/or error) for each size/offset and by selecting a tile size and/or offset associated with one or more performance metrics above a predetermined threshold and/or associated with one or more optimal (e.g., high precision, highest recall, highest accuracy, and/or lowest error) performance metric(s).

The patch sampling module 111 may further define a tile size depending on the type of abnormality being detected. For example, the patch sampling module 111 may be configured with awareness of the type(s) of tissue abnormalities that the whole slide image processing system 110 will be searching for and may customize the tile size according to the tissue abnormalities to optimize detection. For example, the patch sampling module 111 may determine that, when the tissue abnormalities include searching for inflammation or necrosis in lung tissue, the tile size should be reduced to increase the scanning rate, while when the tissue abnormalities include abnormalities with Kupffer cells in liver tissues, the tile size should be increased to increase the opportunities for the whole slide image processing system 110 to analyze the Kupffer cells holistically. In some instances, patch sampling module 111 defines a set of tiles where a number of tiles in the set, size of the tiles of the set, resolution of the tiles for the set, or other related properties, for each image is defined and held constant for each of one or more images.

As embodied herein, the patch sampling module 111 may further define the set of tiles for each digital pathology image along one or more color channels or color combinations. As an example, digital pathology images received by whole slide image processing system 110 may include large-format multi-color channel images having pixel color values for each pixel of the image specified for one of several color channels. Example color specifications or color spaces that may be used include the RGB, CMYK, HSL, HSV, or HSB color specifications. The set of tiles may be defined based on segmenting the color channels and/or generating a brightness map or greyscale equivalent of each tile. For example, for each segment of an image, the patch sampling module 111 may provide a red tile, blue tile, green tile, and/or brightness tile, or the equivalent for the color specification used. As explained herein, segmenting the digital pathology images based on segments of the image and/or color values of the segments may improve the accuracy and recognition rates of the networks used to generating embeddings for the tiles and image and to produce classifications of the image.

Additionally, the whole slide image processing system 110, e.g., using patch sampling module 111, may convert between color specifications and/or prepare copies of the tiles using multiple color specifications. Color specification conversions may be selected based on a desired type of image augmentation (e.g., accentuating or boosting particular color channels, saturation levels, brightness levels, etc.). Color specification conversions may also be selected to improve compatibility between whole slide image generation systems 120 and the whole slide image processing system 110. For example, a particular image scanning component may provide output in the HSL color specification, and the models used in the whole slide image processing system 110, as described herein, may be trained using RGB images. Converting the tiles to the compatible color specification may ensure the tiles may still be analyzed. Additionally, the whole slide image processing system may up-sample or down-sample images that are provided in particular color depth (e.g., 8-bit, 16-bit, etc.) to be usable by the whole slide image processing system. Furthermore, the whole slide image processing system 110 may cause tiles to be converted according to the type of image that has been captured (e.g., fluorescent images may include greater detail on color intensity or a wider range of colors).

As described herein, a patch embedding and encoding module 112 may generate an embedding for each patch in a corresponding feature embedding space. In particular embodiments, patch embedding and encoding module 112 may incorporate one or more aspects of the transformer-based aggregation model. The embedding may be represented by the whole slide image processing system 110 as a feature vector for the patch. The patch embedding and encoding module 112 may use a neural network (e.g., a convolutional neural network (CNN)) to generate a feature vector that represents each patch of the image. In particular embodiments, the CNN used by the patch embedding and encoding module 112 may be customized to handle large numbers of patches of large format images, such as digital pathology whole slide images. Additionally, CNN used by the patch embedding and encoding module 112 may be trained using a custom dataset. For example, the CNN may be trained using a variety of samples of whole slide images or even trained using samples relevant to the subject matter for which the embedding network will be generating embeddings (e.g., scans of particular tissue types). Training the CNN using specialized or customized sets of images may allow the CNN to identify finer differences between patches which may result in more detailed and accurate distances between patches in the feature embedding space at the cost of additional time to acquire the images and the computational and economic cost of training multiple patch sampling networks for use by the patch embedding and encoding module 112. The patch embedding and encoding module 112 may select from a library of CNNs based on the type of images being processed by the whole slide image processing system 110.

As described herein, patch embeddings may be generated from a deep learning neural network using visual features of the patches. Patch embeddings may be further generated from contextual information associated with the patches or from the content shown in the patch. For example, a patch embedding may include one or more features that indicate and/or correspond to morphological features of depicted objects (e.g., sizes of depicted cells or aberrations and/or density of depicted cells or aberrations). Morphological features may be measured absolutely (e.g., width expressed in pixels or converted from pixels to nanometers) or relative to other patches from the same digital pathology image, from a class of digital pathology images (e.g., produced using similar techniques or by a single whole slide image generation system or scanner), or from a related family of digital pathology images. Furthermore, patches may be classified prior to the patch embedding and encoding module 112 generating embeddings for the patches such that the patch embedding and encoding module 112 considers the classification when preparing the embeddings.

For consistency, the patch embedding and encoding module 112 may produce embeddings of a predefined size (e.g., vectors of 512 elements, vectors of 2048 bytes, etc.). The patch embedding and encoding module 112 may produce embeddings of various and arbitrary sizes. The time embedding module 112 may adjust the sizes of the embeddings based on user direction or may be selected, for example, to optimize computation efficiency, accuracy, or other parameters. In particular embodiments, the embedding size may be based on the limitations or specifications of the deep learning neural network that generated the embeddings. Larger embedding sizes may be used to increase the amount of information captured in the embedding and improve the quality and accuracy of results, while smaller embedding sizes may be used to improve computational efficiency.

The patch embedding and encoding module 112 may also encode the embedding for each patch with a spatial attention and a semantic attention. Encoding the embedding with a spatial attention may model a local visual pattern related to one or more histological features in the patch, wherein the local visual pattern spans a region in the WSI beyond the corresponding patch. Encoding the embedding with a semantic attention may model a global visual pattern over the WSI as a whole. The spatial attention and the semantic attention may be aggregated in order to determine a total attention for the patch.

A whole slide image access module 113 may manage requests to access whole slide images from other modules of the whole slide image processing system 110 and the user device 130. For example, the whole slide image access module 113 receive requests to identify a whole slide image based on a particular patch, an identifier for the patch, or an identifier for the whole slide image. The whole slide image access module 113 may perform tasks of confirming that the whole slide image is available to the user requesting, identifying the appropriate databases from which to retrieve the requested whole slide image, and retrieving any additional metadata that may be of interest to the requesting user or module. Additionally, the whole slide image access module 113 may handle efficiently streaming the appropriate data to the requesting device. As described herein, whole slide images may be provided to user devices in chunks, based on the likelihood that a user will wish to see the portion of the whole slide image. The whole slide image access module 113 may determine which regions of the whole slide image to provide and determine how best to provide them. Furthermore, the whole slide image access module 113 may be empowered within the whole slide image processing system 110 to ensure that no individual component locks up or otherwise misuses a database or whole slide image to the detriment of other components or users.

An output generating module 114 of the whole slide image processing system 110 may generate output corresponding to result patch and result whole slide image datasets based on user request. As described herein, the output may include a variety of visualizations, interactive graphics, and reports based upon the type of request and the type of data that is available. In many embodiments, the output will be provided to the user device 130 for display, but in certain embodiments the output may be accessed directly from the whole slide image processing system 110. The output will be based on existence of and access to the appropriate data, so the output generating module will be empowered to access necessarily metadata and anonymized patient information as needed. As with the other modules of the whole slide image processing system 110, the output generating module 114 may be updated and improved in a modular fashion, so that new output features may be provided to users without requiring significant downtime.

The general techniques described herein may be integrated into a variety of tools and use cases. For example, as described, a user (e.g., pathology or clinician) may access a user device 130 that is in communication with the whole slide image processing system 110 and provide a query image for analysis. The whole slide image processing system 110, or the connection to the whole slide image processing system may be provided as a standalone software tool or package that searches for corresponding matches, identifies similar features, and generates appropriate output for the user upon request. As a standalone tool or plug-in that may be purchased or licensed on a streamlined basis, the tool may be used to augment the capabilities of a research or clinical lab. Additionally, the tool may be integrated into the services made available to the customer of whole slide image generation systems. For example, the tool may be provided as a unified workflow, where a user who conducts or requests a whole slide image to be created automatically receives a report of noteworthy features within the image and/or similar whole slide images that have been previously indexed. Therefore, in addition to improving whole slide image analysis, the techniques may be integrated into existing systems to provide additional features not previously considered or possible.

Moreover, the whole slide image processing system 110 may be trained and customized for use in particular settings. For example, the whole slide image processing system 110 may be specifically trained for use in providing insights relating to specific types of tissue (e.g., lung, heart, blood, liver, etc.). As another example, the whole slide image processing system 110 may be trained to assist with safety assessment, for example in determining levels or degrees of toxicity associated with drugs or other potential therapeutic treatments. Once trained for use in a specific subject matter or use case, the whole slide image processing system 110 is not necessarily limited to that use case. Training may be performed in a particular context, e.g., toxicity assessment, due to a relatively larger set of at least partially labeled or annotated images.

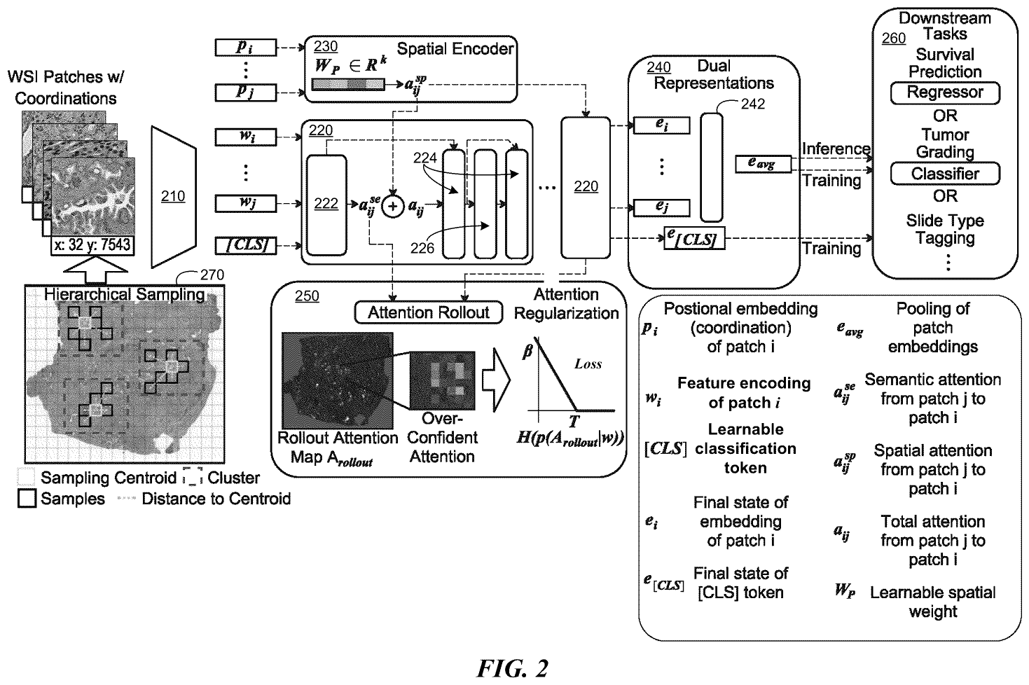

FIG. 2 illustrates an exemplary overview of the transformer-based aggregation model. Patch embeddings extracted from a convolutional neural network (CNN) encoder 210 are further enhanced with semantic (see 220) and spatial (see 230) self-attentions to provide visual context. While the average of encoded patch embeddings is used as the final slide representation, the CLS token output (“e_{[CLS]}”) may be used as input to a classification layer, as well as an auxiliary loss for training (see 240). To avoid over-attention to a few patches, regularization based on an attention rollout method may be derived as the learning objective (see 250). To enable the learning of spatial self-attention, a hierarchical sampling strategy may be applied (see 270). With a final readout of resultant slide representations for specific downstream tasks (see 260), the whole transformer-based aggregation model may be optimized in an end-to-end fashion.

The multiple-instance learning formulation may be followed by considering each WSI as a bag B containing multiple instances of patch x, such that B={x₁, x₂, . . . , xₙ}where xᵢ∈×. Each bag has a label y depending on its contained instances, while the instance labels are unknown. The estimate of bag label may be defined as ŷ=g (f(x₁), . . . , f(xₙ)), wherein f may be the feature extraction transformation and g may be the permutation-invariant transformer-based aggregation model. FIG. 2 illustrates the overall architecture of the disclosed transformer-based aggregation model g. Initial features are extracted for each patch by using a pre-trained CNN encoder (210). However, in principle any feature representation learning approach may be used for this step. After the application of the transformer-based aggregation model, a task-dependent readout may be used for downstream tasks (260).

Semantic and spatial self-attentions may be explicitly encoded with two separate types of encoders. The semantic encoding (220) models global, or macroscopic, visual patterns: the semantic encoding correlates a patch P with the whole slide by attending embeddings of all other patches to P (e.g., enhancing the embedding of the patch P by encoding it with contextual information from the other embeddings) as semantic context. This is motivated by the context of clinical diagnosis, where the impact of local sub-cellular patterns may depend on the co-existence of other patterns in a slide. Such semantic dependence may be achieved, in one non-limiting example, by using a bidirectional self-attention encoder with multi-head attention layers 222, addition and normalization layers 224, and feed forward layer(s) 226 where the explicit cross-attention of patch j to patch i denoted as αse/ij. As an example, the appearance of Gleason scale 3 tissues may be a key indication for grade 1 prostate cancers, while it is less important when Gleason scale 4 glands are primary in a WSI, which is the case for more aggressive prostate cancers. The semantic encoder may be implemented with the bidirectional encoder with multi-head attention layers, with the 1D sequence of patch embeddings {w₁, w₂, . . . , xₙ} from the CNN encoder appended with a learnable token (“[CLS]”) as input. Positional embeddings are not included in input tokens, since the spatial encoder explicitly models the relative position of two patches.

Since sub-cellular structures may be of different scales in WSIs, the spatial encoding models the regional visual patterns that extend beyond the scope of a single patch. The present embodiments may incorporate the spatial encoding by a separate self-attention mechanism. Specifically, bidirectional self-attention between all patches within a local region are modeled. This spatial self-attention method may be decoupled from the aforementioned semantic self-attention by being solely conditioned on the relative distance between two patches.

As shown in 230, the input to the spatial encoder is a sequence of absolution positions of WSI patches {p₁, p₂, . . . , pₙ}. The positions are pre-processed to a standard magnification since of various WSIs can have different resolutions. Denote α^{sp}ᵢⱼ as the spatial attention between patch i and j, where its value is defined as: α^{sp}ᵢⱼ=α^{sp}ⱼᵢ=W_{P}(min (|i −j|, k)), where W_{P}∈R^{k} is a learnable relative positional correlation; and k is the maximum relative distance that spatial dependencies are modeled, beyond which the values are clipped to W_{P}(k). The value of k may be determined based on prior pathological knowledge regarding the specific types of WSIs. At all semantic encoders as in FIG. 2(b), the total self-attention αᵢⱼ of a patch i from a patch j may be a combination of spatial attention and semantic attention, i.e., αᵢⱼ=α^{se}ᵢⱼ+α^{sp}ᵢⱼ.

Additionally, the transformer-based aggregation model applies a hierarchical sampling strategy: for a required bag size N, Kspatially clustered groups of N/Kinstances are selected without overlaps. Cluster centroids are randomly sampled to be in the tissue regions of the WSI. All instances within a group are randomly sampled within a maximum distance of D pixels from the centroid, the value of which may be determined based on the dimensions of sub-cellular structures in a specific pathological task. This approach is designed to sample adequate samples to learn the spatial self-attention encoding. See, 270.

Two aggregation operations are designed to generate slide representation e from the enhanced patch embeddings as shown in 240. First, a learnable classification (CLS) token (“[CLS]”) may be appended to the sequence of patch embeddings prior to the encoding steps, while its final state (“e_{[CLS]}”) after multi-layer encoding may be taken as the representation. Appending the CLS token to the sequence of patch embeddings enables the CLS token to be encoded with all of the representative information of all of the patch embeddings in the sequence. The BERT transformer model provides one example of use of a CLS token being added to a sequence of embeddings. Devlin, J., et al.: BERT: Pre-training of deep bidirectional transformers for language understanding, arXiv preprint arXiv:1810.04805 (2018). Second, a pooling layer 242 that averages all the enhanced patch embeddings may result in an embedding (“e_{avg}”). By using both aggregations, the shared features across both may have broader support from the input data: using e_{avg} as the slide representation and e_{CLS} as the auxiliary embedding for objective training may achieve the highest performance.

Attention-based regularization may reduce over-confidence on a few patches for diagnosis. It is mainly motivated by the clinical practice of pathologists, where multiple regions over multiple patches are commonly picked as patterns of interest and evaluated as a whole for diagnostic conclusions. In particular, attention-based regularization may be implemented using an attention rollout operation, as described in “Quantifying Attention Flow in Transformers,” by Abnar, S. et al., arXiv: 2005.00928v2 (31 May 2020). To implement the regularization, the attention rollout operation may be performed over multi-layer semantic self-attentions to calculate the overall attention Aᵣₒₗₗₒᵤₜ on the WSI. The negative entropy of the overall attention map −H(p(Aᵣₒₗₗₒᵤₜ|w)) may then be added to the overall training objective [symbol] as a hinge loss: [symbol] = [symbol] ₜₐₛₖ+βmax(0, T−H(p(Aᵣₒₗₗₒᵤₜ|w))). [symbol] ₜₐₛₖ is a task-specific loss, β is the weight for controlling the strength of attention-based regularization, and T is the threshold for attention distribution, below which the confidence penalization may be applied to a WSI.

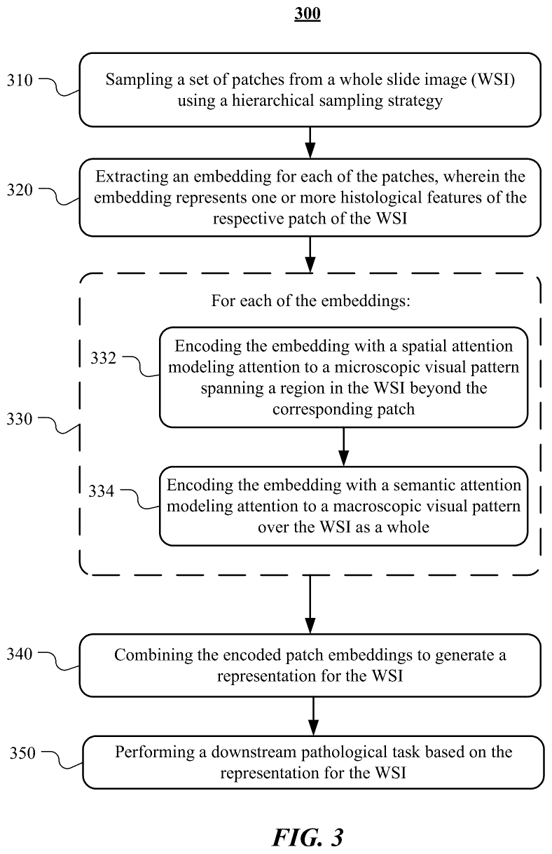

FIG. 3 is a flowchart depicting steps in an example method 300 for analyzing a WSI in light of biological context information. At step 310, patches may be sampled from the WSI. A hierarchical sampling strategy may be applied to randomly selected clusters of the patches. Cluster centroids may be randomly sampled in the tissue regions of the WSI. All patches within a cluster may be randomly sampled within a maximum distance of D micrometers (instead of a fixed pixel distance, since slides can have different resolutions) from the centroid. The value of the maximum distance may be determined based on the dimensions of sub-cellular structures in a specific pathological task.

At step 320, an embedding may be extracted for each of the patches sampled from the WSI, wherein the embedding represents one or more histological features of the respective patch of the WSI. The embeddings may be extracted using a CNN encoder pre-trained to extract the one or more histological features. The CNN encoder may output a one-dimensional sequence of patch embeddings.

At step 330, the embedding for each of the patches may be encoded with a spatial attention and a semantic attention. The spatial attention may model attention to a local visual pattern related to the one or more histological features. The local visual pattern may span a region in the WSI beyond the corresponding patch. The semantic attention may model attention to a global visual pattern over the WSI as a whole.

Encoding the embedding with a spatial attention (step 332) may comprise using a spatial encoder to encode the embedding by attending to embeddings of one or more nearby patches in the set (e.g., enhancing the embedding of the focal patch by encoding it with contextual information from the embeddings of the nearby patches). The nearby patches may be defined as those within a maximum relative distance corresponding to a specified pathological type of the WSI. Input for the spatial encoder may include a positional embedding of the corresponding patch and a sequence of positional embeddings (e.g., absolute positions) of the nearby patches. The positional embeddings may be determined based on normalizing each of the patches to a standard level of magnification.

Encoding the embedding with a semantic attention (step 334) may comprise using a semantic encoder to encode the embedding by attending to embeddings of other patches in the set (e.g., enhancing the embedding of the focal patch by encoding it with contextual information from the embeddings of all of the other sampled patches in the set). The semantic encoder may be a bidirectional self-attention encoder with multi-head attention layers, and wherein the semantic encoder attends embeddings of the other patches in the set. Input for the semantic encoder may include the embeddings of the other patches in the set and a learnable token (“[CLS]”). In some embodiments, the input may comprise a one-dimensional sequence of the other patch embeddings pre-pended with the learnable token. During a training phase, an auxiliary representation of the WSI may be generated based on the encoded learnable token.

At step 340, the encoded patch embeddings may be combined to generate a representation for the WSI. Combining the encoded patch embeddings may comprise taking an average of the encoded embeddings.

At step 350, a downstream pathological task may be performed based on the representation for the WSI. The downstream pathological task may include, by way of example and not limitation, classifying the one or more histological features extracted from the WSI, classifying a pathological type of the WSI, predicting a progression risk of a disease associated with the one or more histological features, or determining a diagnosis of a patient associated with the WSI.

As described above, attention-based regularization may be utilized to reduce the over-emphasis on a few patches. The attention map of a patch i to all patches (e.g., as eᵢ→wⱼ in FIG. 2) in WSIs may be calculated with the rollout operation over all semantic attentions. Spatial attentions are not included since they should be consistent everywhere over a WSI. The overall attention map of the WSI, denoted as Aᵣₒₗₗₒᵤₜ, may be calculated as the average of attention maps at all output tokens (e.g., eᵢ) since they contribute equally to the slide representation. Then, the negative entropy of Aᵣₒₗₗₒᵤₜ is then added to the training objective as a hinge loss:

$${L}_{r e g} = β max ( 0 , T - H ( p ( {A}_{rollout} \vert w ) ) )$$

where β is a hyperparameter for controlling the strength of attention-based regularization; T is the entropy threshold for attention distribution, below which the over-attention penalization may be applied to the model.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for analyzing WSI in light of biological context information including the particular steps of the method of FIG. 3, this disclosure contemplates any suitable method for analyzing WSI in light of biological context information including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

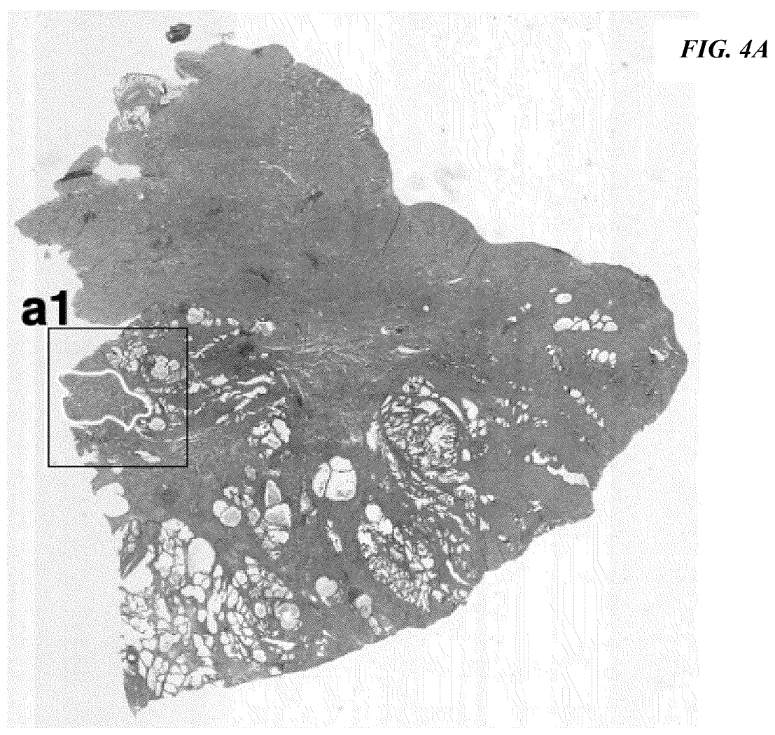

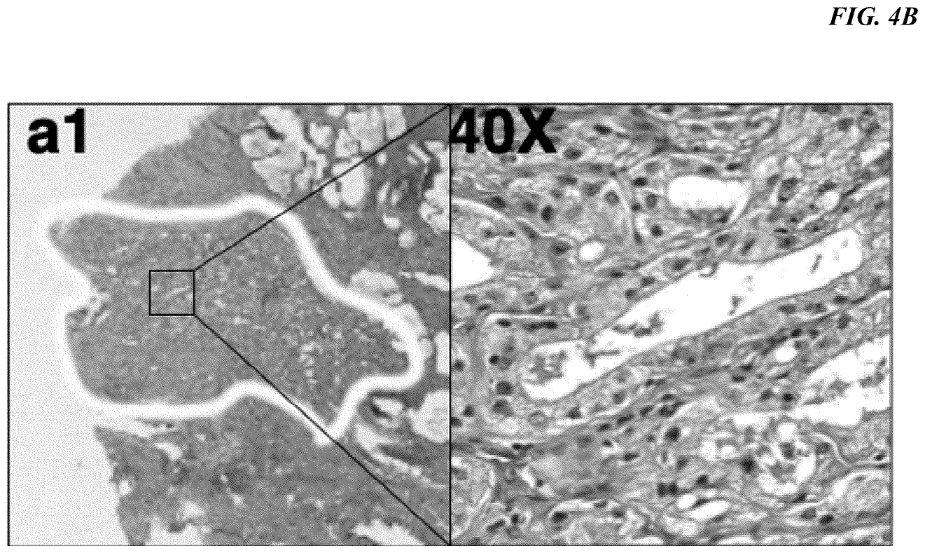

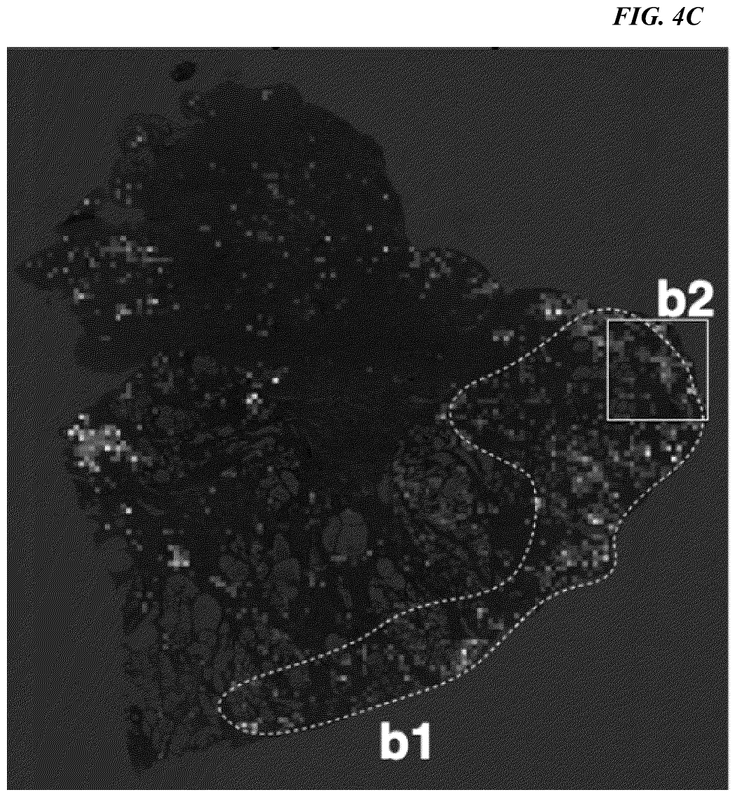

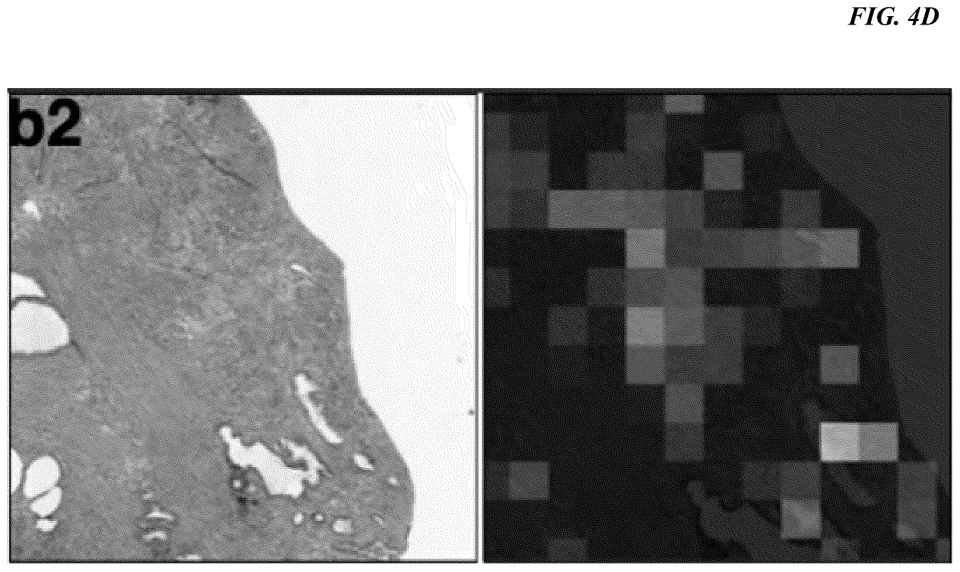

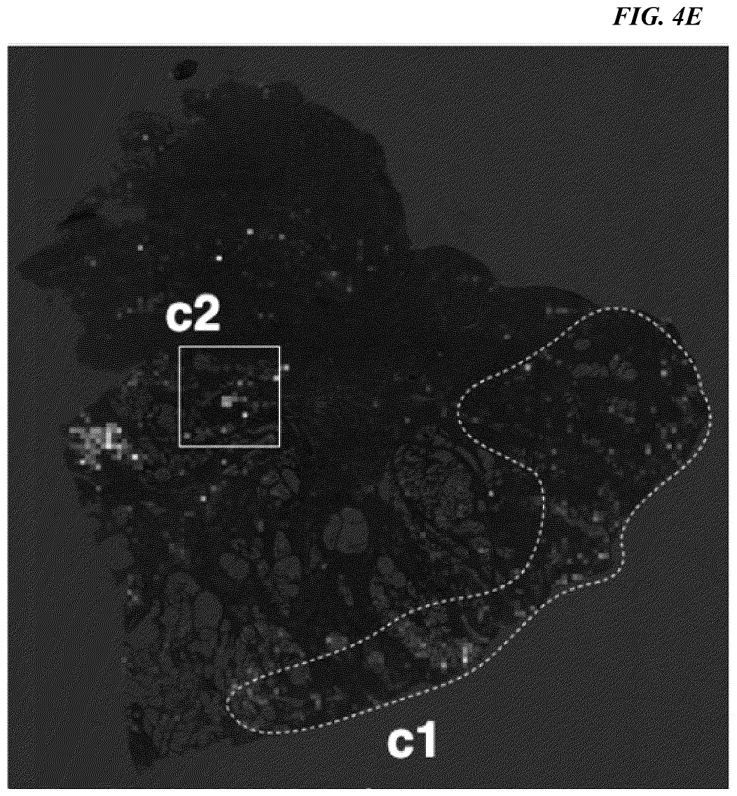

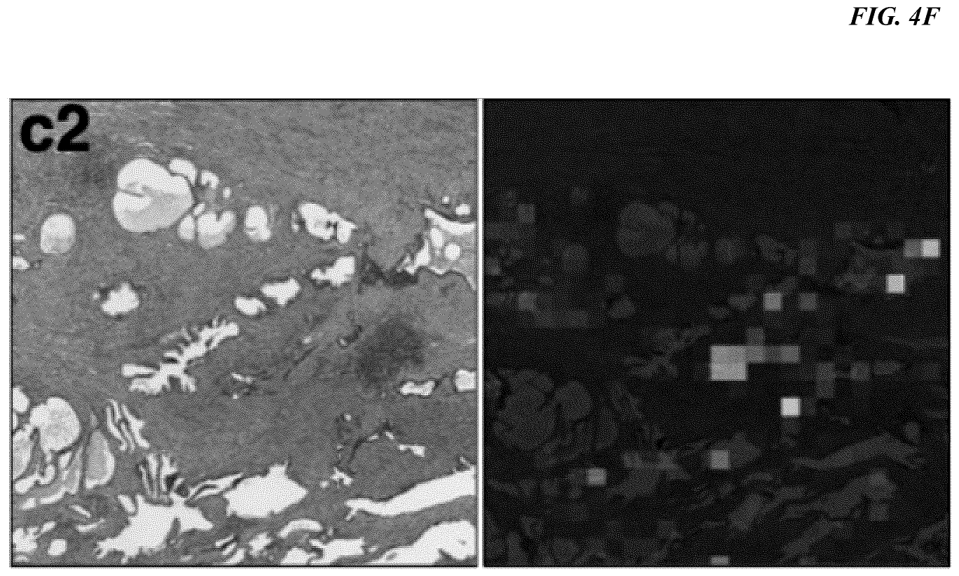

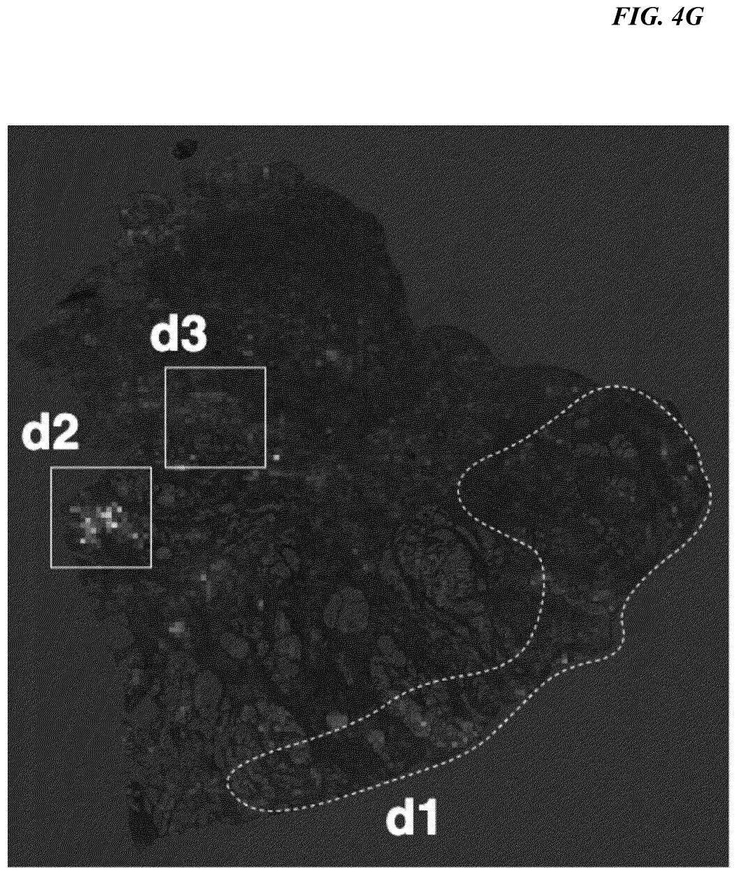

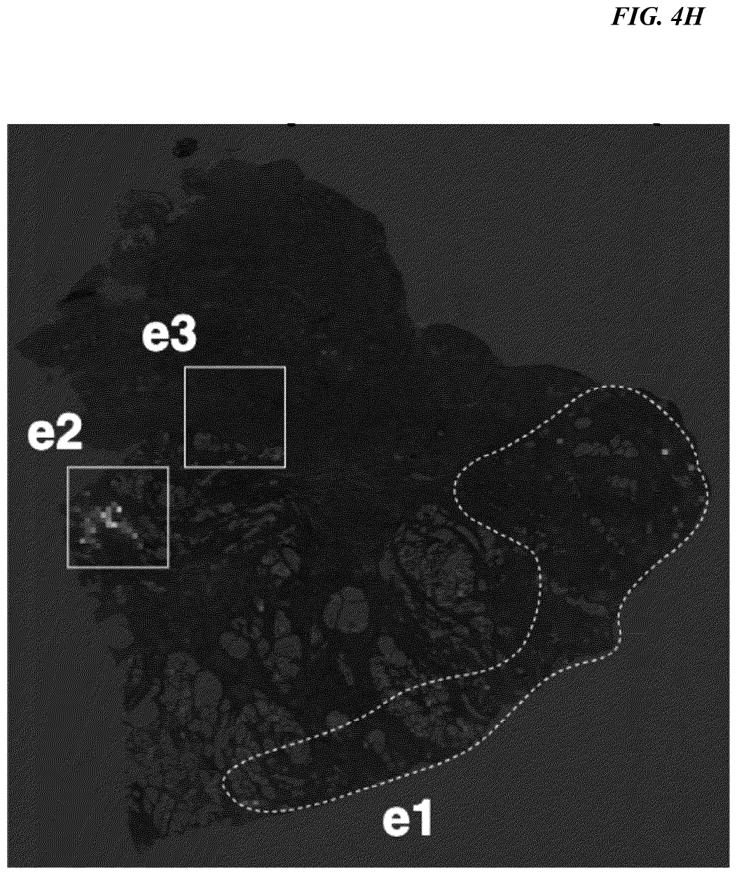

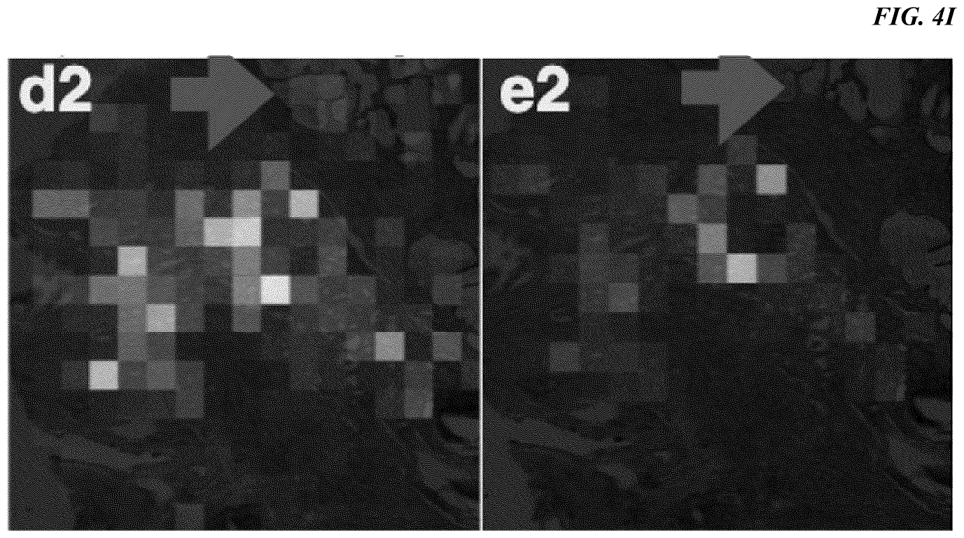

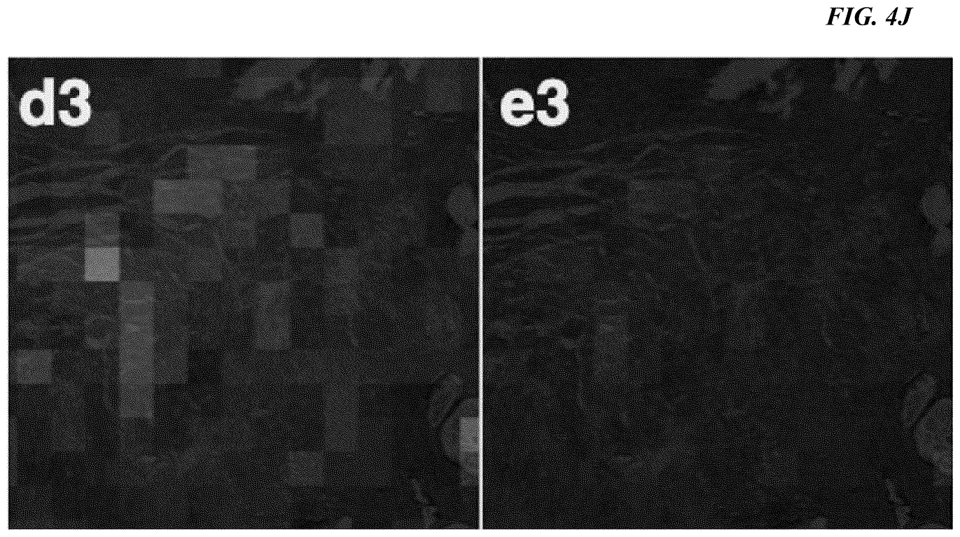

FIGS. 4A-4J illustrate the effect of the semantic and spatial self-attentions and attention regularization by visualizing the attention maps of the ablated models. Specifically, if only using an attention-based multiple-instance learning approach, models may have false positive attentions on non-tumor regions. By adding the spatial self-attention, such false positive attentions may be reduced.

FIG. 4A illustrates an example of a whole slide image including an annotated tumor region al marked with a yellow outline. FIG. 4B illustrates an enlarged view of the annotated tumor region depicted in FIG. 4A, as well as a 40× magnification view of an individual patch within the annotated tumor region.

FIG. 4C illustrates an example of an attention map visualization utilizing an attention-based multiple-instance learning technique. The existing attention-based MIL approach (AB-MIL) produces noisy attention maps with obvious attentions on non-tumor regions b1. FIG. 4D illustrates an enlarged view of a non-tumor region b2 depicted in FIG. 4C, including both the patch from the WSI (shown on the left) and the corresponding attention map visualization (on the right).

In contrast to AB-MIL, the transformer-based aggregation model introduces semantic self-attentions Sₛₑ that enables the improved context for the attention, and thus noisy attentions can be largely reduced. FIG. 4E illustrates an example of an attention map visualization utilizing a semantic self-attention technique. FIG. 4F illustrates an enlarged view of a non-tumor region depicted in FIG. 4E, including both the patch from the WSI (shown on the left) and the corresponding attention map visualization (on the right).

FIG. 4G illustrates an example of an attention map visualization utilizing a semantic self-attention technique, enhanced with an entropy-based attention regularization mechanism. The entropy-based attention regularization mechanism Regₐₜₜ effectively relieves the spurious attentions (see regions c1→d1 and c2→d3, red and purple contours).

FIG. 4H illustrates an example of an attention map visualization utilizing a semantic self-attention technique, enhanced with not only an entropy-based attention regularization mechanism, but also a spatial self-attention technique. The spatial self-attention Sₛₚ models region-level patterns as context, which may help to disambiguate false positive patches (see green regions d→e). FIG. 4I illustrates a comparison between enlarged views of the attention map of FIG. 4G and the attention map of FIG. 4H with respect to the annotated tumor region. FIG. 4J illustrates a comparison between enlarged views of the attention map of FIG. 4G and the attention map of FIG. 4H with respect to a non-tumor region.

The present embodiments include a cross-entropy based attention regularization to avoid the situation where the model only relies on a limited number of patches for predictions. Such regularization Regₐₜₜ may be ablated, and the results in Table 2 show that this boosts the model by 6.85% and 3.73% for both datasets in Kc-score and C-index, respectively (row #4 vs. #5). Such boosts may result in the reduced model overfitting on false positive patches. To demonstrate, FIGS. 4C and 4D show the rollout attention of the versions of the transformer-based aggregation model with (FIG. 4D) and without (FIG. 4C) attention regularization. The model may have more distributed attentions within the tumor regions with Regₐₜₜ, (see pink regions in FIG. 4C and FIG. 4D), and thus false attention on the non-tumor regions may be reduced (see red contours in in FIG. 4C and FIG. 4D).

The transformer-based aggregation model was evaluated on two types of downstream tasks: (i) prostate cancer grading on the TCGA-PRAD dataset, and (ii) lung cancer survival prediction on the TCGA-LUSC dataset. The transformer-based aggregation model may be first compared with the state-of-the-art results, followed by detailed ablation studies on the proposed semantic/spatial self-attention and attention regularization.

All data were downloaded from The Cancer Genome Atlas (TCGA) and only diagnostic formalin fixed/paraffinembedded (FFPE) slides stained with hematoxylin and eosin (H&E) were used. The TCGA-PRAD dataset consists of prostate adenocarcinoma WSIs collected from 19 different medical centers. Each WSI is annotated with a Gleason Score (GS) as an integer ranging from 6 to 10, representing the tumor grade of the sample. A set of 437 WSIs from the TCGA-PRAD dataset were randomly split into three groups of 243 WSIs, 84 WSIs, and 110 WSIs for training, validation, and testing, respectively. Four-fold cross validation was performed, and the average of the results reported. The quadratically-weighted kappa score rc-score was used to evaluate the results.

The TCGA-LUSC dataset consists of lung squamous cell carcinoma WSIs. Each WSI is annotated with the corresponding patient's observed survival time as well as a value that indicatesif a patient died during the observation period. A core data set of 485 WSIs from UT MD Anderson Cancer Center was split into two groups of 388 WSIs and 97 WSIs for training and testing, respectively, for five-fold cross validation. As in survival prediction examples, the transformer-based aggregation model outputs a risk score that is correlated to a patient's survival time. To evaluate the performance of the transformer-based aggregation model, the commonly used concordance index (C-index) was utilized.

Results of these experiments were compared to the state-of-the-art results reported on the two datasets. For TCGA-PRAD, examples include: (i) TMA Supervised trained with the patch-level tissue GP annotations from the Tissue MicroArrays dataset; (ii) Pseudo Patch Labeling trained using slide-level grading as the pseudo labels; and (iii) TMA Fine-Tuning that pre-trains the modelwith patch-level tissue GP predicating and fine-tunes it for slide-level grading with MIL. For TCGA-LUSC, examples include: MTLSA, GCN, DeepCorrSurv, WSISA, DeepGraphSurv, and RankSurv. Moreover, the embodiments described herein are compared with existing multiple-instance learning methods: (i) mean-pooling, (ii) max-pooling, (iii) RNN-based multiple-instance learning (RNN-MIL) for modeling cross-patch dependencies, (iv) attention-based multiple-instance learning (AB-MIL), and (v) dual-stream multiple-instance learning (DS-MIL), which is a transformer-based method for modeling cross-patch dependencies, for both datasets.

Table 1 shows results obtained on the TCGA-PRAD dataset as measured with weighted kappa score (x-score) in the format of mean±std.

| Methods | κ-score (%) | Methods | C-index (%) |
|---|---|---|---|
| TMA Supervised | 52.47 | MTLSA | 62.23 |
| Pseudo Patch Labeling | 56.75 | GCN | 62.80 |
| TMA Fine-Tuning | 65.32 | DeepCorrSurv | 62.87 |
| Mean-pooling | 52.05 | WSISA | 63.80 |
| Max-pooling | 56.81 | DeepGraphSurv | 66.06 |
| RNN-MIL | 59.52 | RankSurv | 67.13 |
| AB-MIL | 65.50 | Mean-pooling | 57.38 |
| DS-MIL | 58.39 | Max-pooling | 61.10 |
| WSITrans (ours) | 69.09 | RNN-MIL | 57.11 |
| | | AB-MIL | 61.33 |
| | | DS-MIL | 62.37 |
| | | WSITrans (ours) | 67.70 |

Table 1 presents the results for the transformer-based aggregation model as compared to the above-mentioned methods: (1) for the TCGA-PRAD dataset as measured in weighted kappa score (κ-score), and (2) for the TCGA-LUSC dataset as measured in C-index. As shown in Table 1, the results illustrate that the transformer-based aggregation model outperforms the aforementioned approaches by at least 3.67% in κ-score on TCGA-PRAD. Compared to TMA Fine-Tuning, the transformer-based aggregation model achieves superior results without relying on the extra tissue pattern learning. Similarly, the transformer-based aggregation model achieves the highest accuracy for TCGA-LUSC. Notably, DeepGraphSurv introduces cross-patch dependencies conditioned on patch visual features with spectral graph convolution. However, the transformer-based aggregation model surpasses it by 1.64% in C-index, possibly because DeepGraphSurv may only include a limited number of patches from selected regions of interest, which constraints its ability to capture slide-level patterns.

Table 2 shows results obtained from an ablation study of different building blocks for the performance of the transformer-based aggregation model (rows #1-5). AB-MIL without self-attention is used as the weak baseline (row #6), and the DS-MIL with single-layer limited-connected cross-attention as the strong baseline (row #7). κ-score and C-index are used as the measurements for TCGA-PRAD and TCGA-LUSC datasets.

| | | | | | | TCGA-PRAD | TCGA-LUSC |
|---|---|---|---|---|---|---|---|
| # | Baseline | +SAₛₑ | +Regₐₜₜ | +SAₛₚ | +HS | κ-score (%) | C-index (%) |
| 1 | ✓ | ✓ | | | | 66.42 (+0.92) | 65.47 (+4.14) |
| 2 | ✓ | ✓ | ✓ | | | 68.13 (+2.63) | 67.94 (+6.61) |
| 3 | ✓ | ✓ | ✓ | ✓ | | 64.50 (−1.00) | 61.18 (−0.15) |
| 4 | ✓ | ✓ | | ✓ | ✓ | 62.24 (−3.26) | 64.30 (+2.97) |
| 5 | ✓ | ✓ | ✓ | ✓ | ✓ | 69.09 (+3.59) | 68.03 (+6.70) |

| | | | |
|---|---|---|---|
| 6 | AB-MIL (weak baseline) | 65.50 | 61.33 |
| 7 | DS-MIL (strong baseline) | 58.39 | 67.69 |

Table 2 shows that semantic self-attention SAₛₑ alone enables boosts of 2.63% and 6.61% (row #2 vs. #6). Meanwhile, adding spatial self-attention SAₛₚ enables additional boosts (row #2 vs. #5) for both of the two datasets in κ-score and C-index respectively. This demonstrates that the two self-attentions contribute differently to modeling visual context and should both be incorporated. Compared to the strong baseline of DS-MIL, whichcontains a single layer semantic self-attention between one pre-defined patch and other patches, the deeper and wider semantic attention layers over all patch pairs of the transformer-based aggregation model enable a significant boost on the TCGA-PRAD dataset (row #5 vs. #7). Moreover, it appears that the hierarchical sampling strategy is important for learning the spatial self-attentions, since disabling it results in performance drops for the both datasets in κ-score and C-index respectively (row #3 vs. #5).

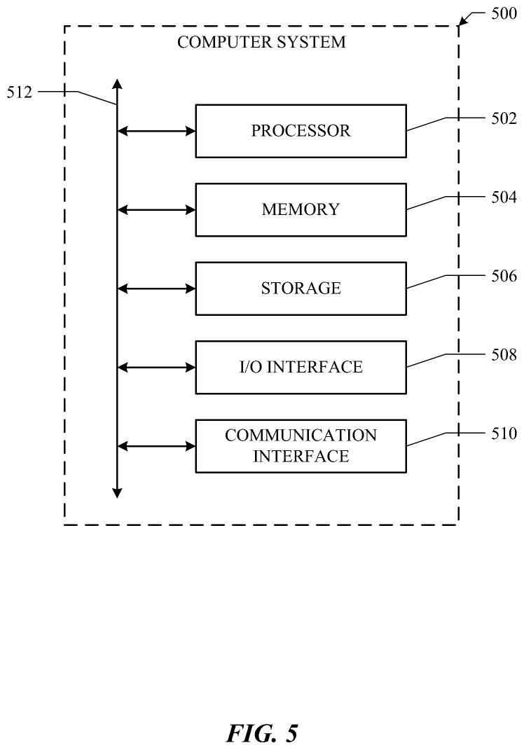

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A computer-implemented method for analyzing a whole slide image (WSI) in light of biological context, comprising:
extracting an embedding for each of a set of patches sampled from a WSI, wherein the embedding represents one or more histological features of the respective patch of the WSI;
for each of the patches, encoding the corresponding embedding with a spatial context and a semantic context, wherein the spatial context represents a local pattern related to the one or more histological features, the local visual pattern spanning a region in the WSI beyond the corresponding patch, and wherein the semantic context represents a global pattern over the WSI as a whole;
generating a representation for the WSI by combining the encoded patch embeddings; and
performing a pathological task based on the representation for the WSI.

2. The method of claim 1, wherein the patches are sampled by applying a hierarchical sampling strategy to a randomly selected plurality of clusters of the patches.

3. The method of claim 2, further comprising applying the hierarchical sampling strategy by:
for each of the randomly selected clusters:
randomly sampling a centroid of the cluster;
for each of the patches in the cluster, determining a distance of the patch to the centroid; and
randomly sampling all patches in the cluster having a distance to the centroid within a threshold distance.

4. The method of claim 3, wherein the threshold distance is based on the pathological task.

5. The method of claim 1, wherein encoding the embedding with the spatial context comprises using a spatial encoder to encode the embedding with spatial attention by attending to embeddings of one or more nearby patches in the set.

6. The method of claim 5, wherein the one or more nearby patches are defined as those within a maximum relative distance corresponding to a specified pathological type of the WSI.

7. The method of claim 5, wherein input for the spatial encoder comprises: a position of the corresponding patch and a sequence of absolute positions of the nearby patches.

8. The method of claim 7, wherein the absolute positions are normalized to correspond to a standard level of magnification.

9. The method of claim 1, wherein encoding the embedding with a semantic context of the corresponding patch comprises using a semantic encoder to encode the embedding with semantic attention by attending to embeddings of other patches in the set.

10. The method of claim 9, wherein the semantic encoder is a bidirectional self-attention encoder with multi-head attention layers, and wherein the semantic encoder attends embeddings of the other patches in the set.

11. The method of claim 9, wherein input for the semantic encoder comprises the embeddings of the other patches in the set and a learnable token.

12. The method of claim 11, wherein, during a training phase, generating a representation of the WSI based on the encoded patch embeddings comprises generating an auxiliary representation based on the encoded learnable token.

13. The method of claim 9, further comprising:
enhancing the semantic context by regularizing the semantic attention to reduce overemphasis on a few of the patches to generate the representation for the WSI.

14. The method of claim 13, wherein regularizing the semantic attentions comprises:
calculating an attention map over the semantic attentions encoded for the embeddings corresponding to patches sampled from the WSI; and
adding a negative entropy of the attention map to a training objective of the transformer model.

15. The method of claim 1, wherein combining the encoded patch embeddings comprises taking an average of the encoded embeddings.

16. The method of claim 1, wherein performing a pathological task based on the annotation of the WSI comprises:
classifying the one or more histological features extracted from the WSI;
classifying a pathological type of the WSI;
predicting a progression risk of a disease associated with the one or more histological features; or
determining a diagnosis of a patient associated with the WSI.

17. The method of claim 16, wherein the pathological task may be performed using a classifier model or a regressor model.

18. One or more computer-readable non-transitory storage media embodying software for analyzing a whole slide image (WSI) in light of biological context, the software comprising instructions operable when executed to:
extract an embedding for each of a set of patches sampled from a WSI, wherein the embedding represents one or more histological features of the respective patch of the WSI;
for each of the patches, encode the corresponding embedding with a spatial context and a semantic context, wherein the spatial context represents a local pattern related to the one or more histological features, the local visual pattern spanning a region in the WSI beyond the corresponding patch, and wherein the semantic context represents a global pattern over the WSI as a whole;
generate a representation for the WSI by combining the encoded patch embeddings; and
perform a pathological task based on the representation for the WSI.

19. A system for analyzing a whole slide image (WSI) in light of biological context comprising one or more processors and a memory coupled to the processors comprising instructions executable by the processors, the processors being operable when executing the instructions to:
extract an embedding for each of a set of patches sampled from a WSI, wherein the embedding represents one or more histological features of the respective patch of the WSI;
for each of the patches, encode the corresponding embedding with a spatial context and a semantic context, wherein the spatial context represents a local pattern related to the one or more histological features, the local visual pattern spanning a region in the WSI beyond the corresponding patch, and wherein the semantic context represents a global pattern over the WSI as a whole;
generate a representation for the WSI by combining the encoded patch embeddings; and
perform a pathological task based on the representation for the WSI.

20. A computer-implemented method for analyzing a whole slide image (WSI) in light of biological context, comprising:
extracting an embedding for each of a set of patches sampled from a WSI, wherein the embedding represents one or more histological features of the respective patch of the WSI;
for each of the patches:
encoding, by a spatial encoder, the embedding corresponding to the patch with a spatial attention by attending to the embeddings of nearby patches in the set, wherein the spatial attention models attention to a microscopic visual pattern related to the one or more histological features, the microscopic visual pattern spanning a region in the WSI beyond the corresponding patch; and
encoding, by a semantic encoder, the embedding corresponding to the patch with a semantic attention by attending to the embeddings of all other patches in the set, wherein the semantic attention models attention to a macroscopic visual pattern over the WSI as a whole;
generating a representation for the WSI by combining the encoded patch embeddings; and
performing a pathological task based on the representation for the WSI.
